(19) United States
(12) Patent Application Publication
(10) Pub. No.: US 2026/0158777 A1
(43) Pub. Date: Jun. 11, 2026

(54) MUG HEAT PRESS AND HEAT PRESS

(71) Applicant: HUNAN SIJIU TECHNOLOGY CO., LTD, Changsha (CN)

(72) Inventors: Min AI, Changde (CN); Wenxiong HUANG, Huazhou City (CN); Bangxing XIE, Ganzhou (CN)

(73) Assignee: HUNAN SIJIU TECHNOLOGY CO., LTD, Changsha (CN)

(21) Appl. No.: 19/477,640

(22) PCT Filed: Feb. 23, 2024
(86) PCT No.: PCT/CN2024/078356

§ 371 Date: Feb. 25, 2026

(30) Foreign Application Priority Data
Feb. 24, 2023 (CN) 202310165637.5
Feb. 24, 2023 (CN) 202320309325.2
Feb. 24, 2023 (CN) 202320315323.4
Apr. 28, 2023 (CN) 202321049335.3
May 31, 2023 (CN) 202321373082.5

(51) Int. Cl. B41F 16/00

(52) U.S. Cl. CPC B41F 16/0086; B41F 16/0046; B41F 16/0093

(57) ABSTRACT

A mug heat press is disclosed, including: a frame; a flexible heater, having a first port and a second port arranged horizontally, and a pressing channel having an arc-shaped wall and communicating the first port and the second port, where an upper portion of the pressing channel has a groove opening defined by a first edge and a second edge of the flexible heater, two ends of the groove opening are respectively in communication with the first port and the second port, and an inner diameter of the pressing channel is adjustable via the second edge; and a driving device, including a transmission member connected to the second edge of the flexible heater, and a driver configured to drive the transmission member to drive the second edge to move relative to the first edge.

### CROSS-REFERENCE TO RELATED APPLICATIONS

This application is a U.S. National Phase Application under 35 U.S.C. § 371 of International Patent Application No. PCT/CN2024/078356, filed on Feb. 23, 2024, which is filed on the basis of and claims priority from Chinese patent application No. 2023101656375, filed Feb. 24, 2023 and entitled “MUG HEAT PRESS”, Chinese patent application No. 2023203093252, filed Feb. 24, 2023 and entitled “MUG HEAT PRESS”, Chinese patent application No. 2023203153234, filed Feb. 24, 2023, Chinese patent application No. 2023210493353, filed Apr. 28, 2023 and entitled “HEAT PRESS”, and Chinese patent application No. 2023213730825, filed May 31, 2023 and entitled “HEAT PRESS”, and claims priority to the Chinese patent applications, all of which are incorporated by reference as if expressly set forth in their respective entireties herein.

### TECHNICAL FIELD

The present disclosure belongs to the technical field of thermal-transfer printing, and specifically to a mug heat press and a heat press.

### BACKGROUND

A heat press is used for thermally transferring a pattern onto the surface of a cylindrical object, e.g., to an outer surface of a mug. Existing heat presses adopt a flexible heater with an avoidance gap. Some heat presses adopt one vertically arranged flexible heater, which can transfer a pattern to only one object at a time. Some heat presses adopt two horizontally arranged flexible heaters, each of which can transfer a pattern to one object. For another example, in a scheme disclosed in Chinese Patent Application No. CN215590223U, a flexible heater is arranged vertically, and a pneumatic driving device is used for the pressing operation. Such a scheme can only press one object at a time, resulting in poor applicability. For example, Chinese Patent Application No. CN109940976A discloses a scheme using two horizontally arranged flexible heaters, which requires operation personnel to press two objects respectively with two hands, leading to problems such as uneven pressure, poor transfer quality, and inconvenient operation.

U.S. Patent Application No. US20220258514A1 entitled “Sublimation Systems and Related Methods” discloses a scheme using vertically arranged flexible heaters, where a workpiece engagement actuator is manually operated for the pressing operation. In the scheme disclosed in CN215590223U, a motor is used to drive a stud to push the flexible heater for pressing. Because the flexible heater is vertically arranged in the above two schemes, these two schemes can be applied only to objects with limited height. When the height of the object exceeds the height of the flexible heater, the pattern position cannot be adjusted, resulting in poor applicability. Some manufacturers have designed heat presses using a horizontally arranged flexible heater. For example, Chinese Patent Application No. CN214294998U discloses a scheme using a horizontally arranged flexible heater with openings at both ends. However, this scheme requires manual operation and is troublesome to operate and inefficient.

It is found that the reason why existing electric schemes adopt a vertically arranged flexible heater lies in that the circuit module and the driver are arranged opposite to the flexible heater, and the circuit module is arranged above the driver, so as to isolate the heat generation of the flexible heater and the lubrication of the driver from the circuit module.

### SUMMARY

An objective of the present disclosure is to solve the problems in the prior art including poor applicability, uneven pressure, poor transfer quality, and inconvenient operation caused by the fact that simultaneous transfer printing of two objects requires operation with both hands. In the present disclosure, to solve the above problems, a flexible heater is horizontally arranged, a horizontal screw actuator is used to push the flexible heater to roll up, and a torque bias guide mechanism is arranged on two sides of the screw actuator.

The following technical schemes are employed in the present disclosure.

A mug heat press is provided, including: a frame; a flexible heater, having a first port and a second port arranged horizontally, and a pressing channel having an arc-shaped wall and communicating the first port and the second port, where an upper portion of the pressing channel has a groove opening defined by a first edge and a second edge of the flexible heater, two ends of the groove opening are respectively in communication with the first port and the second port, and an inner diameter of the pressing channel is adjustable via the second edge; a driving device, including a transmission member, elastic coupling members connecting two sides of the second edge and two sides of the transmission member, and a driver configured to drive the transmission member to drive the second edge to move relative to the first edge; and a torque bias guide mechanism, arranged on two sides of the transmission member and configured to guide and adjust a movement of the transmission member.

In the present disclosure, the torque bias guide mechanism and the elastic coupling members can effect a corrective bias adjustment when an uneven force is applied to two sides of the heat-pressing flexible heater, to ensure the conformity between a pressed object and a transfer material, thereby achieving automated pressing. The mug heat press can automatically implement thermal-transfer printing of one object and simultaneous thermal-transfer printing of two objects, and is suitable for thermal-transfer printing of an object with a curved outer diameter without being affected by the placement position of the object, thereby achieving good applicability.

Further, the torque bias guide mechanism includes a guide wheel mounted on the transmission member and a guide groove configured to be fitted with the guide wheel, and a width of the guide groove is configured in a way such that an adjustment clearance exists between the guide groove and the guide wheel. The above scheme achieves a simple and reliable structure and provides a good bias guide effect.

Further, each of the elastic coupling members includes a guide column connected to the first edge, a guide sleeve slidably engaged with the guide column and connected to the transmission member, and an elastic member mounted between the guide sleeve and the guide column. The above scheme provides an elastic resetting effect and a guiding effect, enabling the transmission member to move smoothly and achieving a good elastic adjustment effect.

Further, the driver includes a driving mechanism and a screw nut pair, the screw nut pair includes a screw nut and a screw rod, the screw nut is connected to the transmission member, and an output end of the driving mechanism is drive-connected to the screw rod. Specifically, the driving mechanism includes a motor and a speed variator, the motor is drive-connected to an input end of the speed variator, and an output end of the speed variator is drive-connected to the screw rod. The above scheme provides a linear driving force and a well-controlled pressing force and has a compact structure which makes the product small.

Further, the frame includes a frame bottom wall, and a first mounting part and a second mounting part formed on the frame bottom wall, a heater mounting chamber with an upper opening is provided between the first mounting part and the second mounting part, the first edge of the flexible heater is mounted on the first mounting part, and the driver is mounted on the second mounting part. Such a configuration optimizes the mounting structure and makes the product structure compact.

Further, the second mounting part includes two supporting bases arranged opposite to each other and perpendicular to an axis of the heater mounting chamber, the torque bias guide mechanism includes guide wheels mounted on the transmission member and guide grooves respectively provided on upper sides of the two supporting bases, the guide wheels are configured to be fitted with the corresponding guide grooves, and a width of each of the guide grooves is configured in a way such that an adjustment clearance exists between the each of the guide grooves and the respective guide wheel. Such a configuration enables the frame to have a high structural strength, further optimizes the mounting structure, and makes the product structure more compact.

Further, a driver connection portion is arranged on rear sides of the two supporting bases, the driver is mounted on the driver connection portion, the driver includes a driving mechanism and a screw nut pair, the screw nut pair includes a screw nut and a screw rod, the screw nut is connected to the transmission member, the driving mechanism includes a motor and a speed variator, the motor is drive-connected to an input end of the speed variator, and an output end of the speed variator is drive-connected to the screw rod.

Further, the frame is injection molded, and the frame bottom wall is formed with a plurality of reinforcing rib structures perpendicular to an axis of the heater mounting chamber, and/or a reinforcing member extending across the heater mounting chamber is mounted on the frame bottom wall. The above scheme is cost-effective and lightweight and has a high structural strength which can effectively prevent the deformation of the frame during thermal-transfer printing.

Another objective of the present disclosure is to solve the problems that horizontal flexible heating schemes in the prior art require manual operation and are troublesome to operate and inefficient. In the present disclosure, to solve the above problems, a flexible heater is horizontally arranged, and a driving device is used to push the flexible heater to roll up.

A mug heat press is provided, including: a frame; a flexible heater, having a first port and a second port arranged horizontally, and a pressing channel having an arc-shaped wall and communicating the first port and the second port, where an upper portion of the pressing channel has a groove opening defined by a first edge and a second edge of the flexible heater, two ends of the groove opening are respectively in communication with the first port and the second port, and an inner diameter of the pressing channel is adjustable via the second edge; and a driving device, including a transmission member, elastic coupling members connecting two sides of the second edge and two sides of the transmission member, and a driver configured to drive the transmission member to drive the second edge to move relative to the first edge.

In the present disclosure, because the pressing channel has openings at both ends, a user can conveniently move an object leftward or rightward to adjust the position of thermal-transfer printing. Automated control is adopted to make the operation simple. The elastic coupling members can ensure a uniform pressure during thermal-transfer printing, thereby improving the effect of thermal-transfer printing.

As an alternative, a mug heat press is provided, including: a frame; a flexible heater, having a first port and a second port arranged horizontally, and a pressing channel having an arc-shaped wall and communicating the first port and the second port, where an upper portion of the pressing channel has a groove opening defined by a first edge and a second edge of the flexible heater, two ends of the groove opening are respectively in communication with the first port and the second port, and an inner diameter of the pressing channel is adjustable via the second edge; and a driving device, including a transmission member connected to two sides of the second edge of the flexible heater, and a driver configured to drive the transmission member to drive the second edge to move relative to the first edge.

In the present disclosure, because the pressing channel has openings at both ends, a user can conveniently move an object leftward or rightward to adjust the position of thermal-transfer printing. Automated control is adopted to make the operation simple. As such, the effect of thermal-transfer printing is improved.

It is found that an important reason why existing horizontally arranged flexible heaters cannot realize automation is the rigidity issue of the frame. When the frame is made of plastic, because the frame is provided with a heater mounting chamber corresponding to the flexible heater, the bottom wall of the heater mounting chamber is not rigid enough, and deforms significantly under a force applied by the driving device, so the thermal-transfer printing effect cannot be ensured. The present disclosure provides the following technical scheme.

A mug heat press is provided, including: a frame, which is injection molded and includes a bottom wall, and a first mounting part and a second mounting part formed on an upper side of the bottom wall of the frame, where a heater mounting chamber with an upper opening is provided between the first mounting part and the second mounting part; a reinforcing structure, including a stepped structure formed on the bottom wall and extending across the heater mounting chamber, and/or a reinforcing member mounted at a bottom of the bottom wall across the heater mounting chamber; a flexible heater, having a first port and a second port arranged horizontally, and a pressing channel having an arc-shaped wall and extending to the first port and the second port, where an upper portion of the pressing channel has a groove opening defined by a first edge and a second edge of the flexible heater, two ends of the groove opening are respectively in communication with the first port and the second port, the first edge of the flexible heater is mounted on the first mounting part, and an inner diameter of the pressing channel is adjustable via the second edge; and a driving device, mounted on the second mounting part, and including a transmission member connected to two sides of the second edge of the flexible heater, and a driver configured to drive the transmission member to drive the second edge to move relative to the first edge.

Because the pressing channel extends to the first port and the second port, a user can adjust the position of the object in the pressing channel as required, thereby adjusting the position at which a pattern is to be printed. Automated pressing is achieved using the driving device. The arrangement of the reinforcing structure on the bottom wall of the frame can ensure the structural strength of the bottom wall of the heater mounting chamber, so that during thermal-transfer printing, the bottom wall does not deform to affect the thermal-transfer printing effect. The stepped structure and the reinforcing member can effectively improve the structural strength of the bottom wall of the heater mounting chamber.

Another objective of the present disclosure is to solve the problem in the prior art that the flexible heater has to be vertically arranged because the layout of the circuit module, the flexible heater, and the driver requires arranging the circuit module and the driver on a side opposite to the flexible heater and arranging the circuit module above the driver. In the present disclosure, to solve the above problem, the main control board and the control board are respectively arranged at two ends of the frame, and the main control board is mounted in the main control chamber which is separated from the driving device.

A heat press is provided, including: a frame, including a first mounting part and a second mounting part arranged spaced part in a horizontal direction, a frame bottom wall, and a heater mounting area with an upper opening and adjacent to the first mounting part; a flexible heater, mounted in heater mounting area, and having a first port and a second port arranged horizontally, and a pressing channel formed between the first port and the second port, where an upper portion of the pressing channel has a groove opening defined by a first edge and a second edge of the flexible heater, the first edge of the flexible heater is fixedly mounted on one side of the heater mounting area, and an inner diameter of the pressing channel is adjustable via the second edge; a driving device, mounted on the second mounting part and including a driver configured to drive the second edge to move relative to the first edge; and a control circuit, including a main control board and a control board, where the second mounting part on the frame bottom wall is provided with a main control chamber with a lower opening, and a main control chamber cover configured to open and close the main control chamber, the main control board is mounted in the main control chamber, and the control board is mounted on the first mounting part of the frame.

The main control board and the control board are respectively arranged at two ends of the frame, to facilitate the mounting and maintenance of the main control board and prevent a heat source from affecting the control board and the main control board. In addition, the main control board is mounted in the main control chamber which is separated from the driving device, to prevent a lubricating medium of the driving device from affecting the main control board, so there is no need to provide a protective structure for the main control board. Through the horizontal arrangement of the flexible heater, a user can conveniently move an object leftward or rightward to adjust the position of thermal-transfer printing, and simultaneous thermal-transfer printing of two objects can be achieved.

### BRIEF DESCRIPTION OF DRAWINGS

FIG. 1 is a schematic perspective view of a mug heat press;

FIG. 2 is a schematic perspective view of a mug heat press from another angle;

FIG. 3 is a schematic exploded perspective view of a mug heat press (housing);

FIG. 4 is a schematic exploded perspective view of a mug heat press (housing) from another angle;

FIG. 5 is a schematic perspective view of a mug heat press, where a housing is not shown;

FIG. 6 is a schematic perspective view of a mug heat press from another angle, where a housing is not shown;

FIG. 7 is an exploded view 1 of FIG. 5;

FIG. 8 is an exploded view 1 of FIG. 6;

FIG. 9 is an exploded view 2 of FIG. 5;

FIG. 10 is an exploded view 2 of FIG. 6;

FIG. 11 is a schematic perspective view of a driving device and a flexible heater;

FIG. 12 is a schematic perspective view of a driving device and a flexible heater from another angle;

FIG. 13 is a schematic perspective view of a driving device;

FIG. 14 is a schematic perspective view of a driving device from another angle;

FIG. 15 is a cross-sectional view 1 of a driving device;

FIG. 16 is a cross-sectional view 1 of a driving device from another angle;

FIG. 17 is a cross-sectional view 2 of a driving device;

FIG. 18 is a cross-sectional view 2 of a driving device from another angle;

FIG. 19 is a schematic perspective view of a driver;

FIG. 20 is a schematic perspective view of a driver from another angle;

FIG. 21 is an exploded view of a driver;

FIG. 22 is an exploded view of a driver from another angle;

FIG. 23 is a schematic perspective view 1 of a transmission member;

FIG. 24 is a schematic perspective view 2 of a transmission member from another angle;

FIG. 25 is a schematic perspective view 3 of a transmission member;

FIG. 26 is a schematic perspective view 4 of a transmission member from another angle;

FIG. 27 is a schematic perspective view of a frame;

FIG. 28 is a schematic perspective view of a frame from another angle;

FIG. 29 is a cross-sectional view taken along line A-A in FIG. 27;

FIG. 30 is an exploded view of a frame;

FIG. 31 is an exploded view of a frame from another angle;

FIG. 32 is a cross-sectional view of a frame taken along another direction;

FIG. 33 is a schematic perspective view of a frame from another angle;

FIG. 34 is a schematic perspective view of a frame from a bottom-view angle;

FIG. 35 is a partially exploded view of FIG. 24;

FIG. 36 is a partial exploded perspective view of a frame from another bottom-view angle; and

FIG. 37 is a top perspective view of a frame.

### DETAILED DESCRIPTION

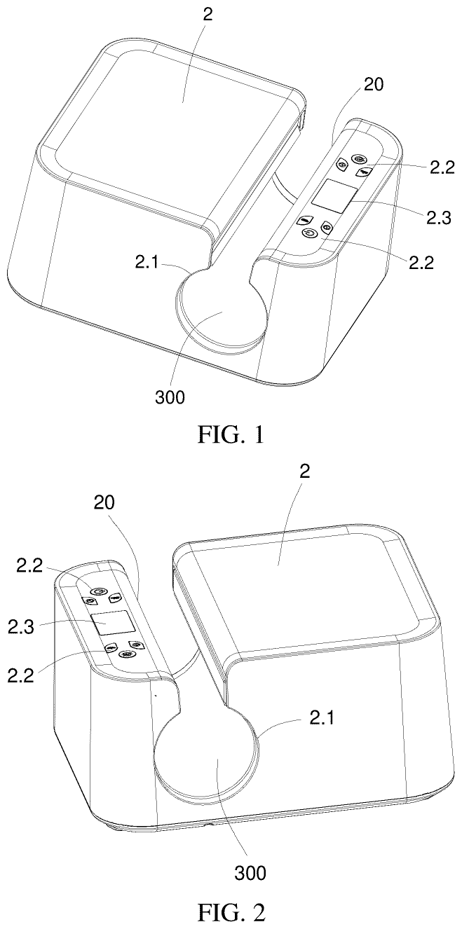

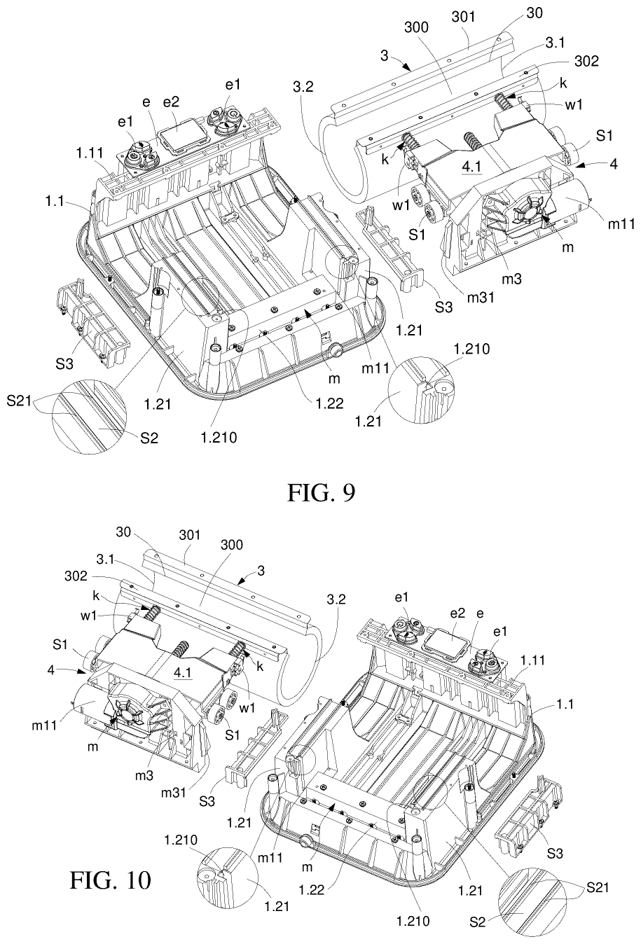

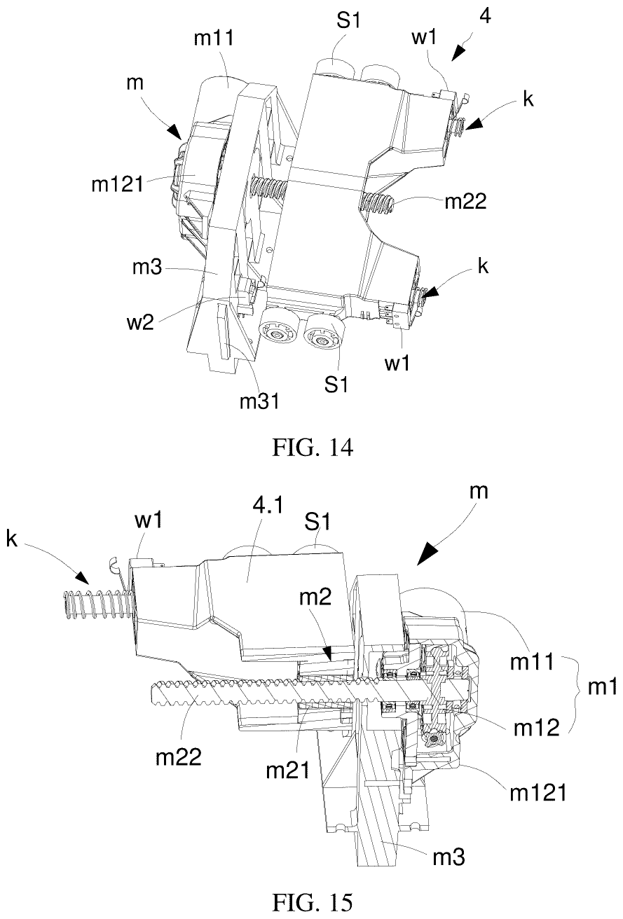

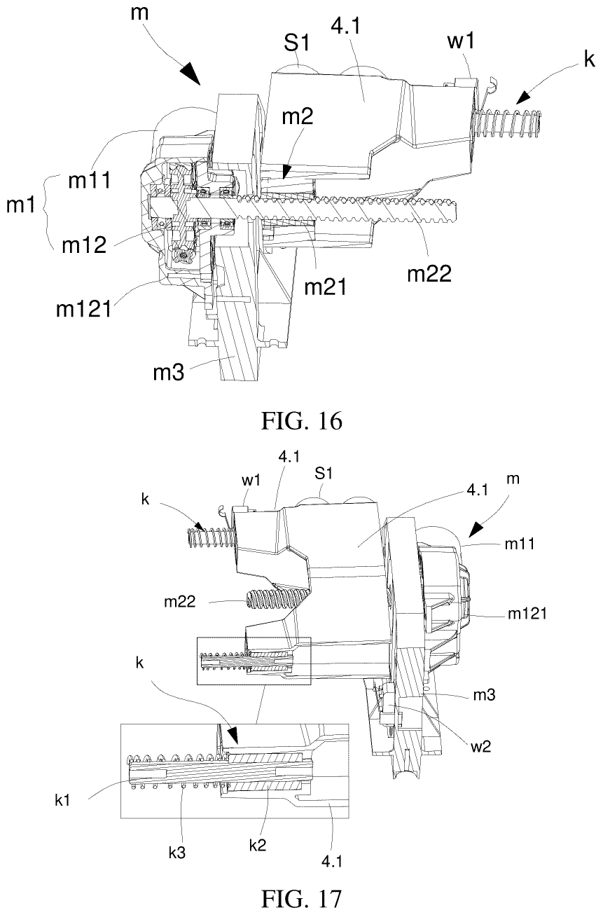

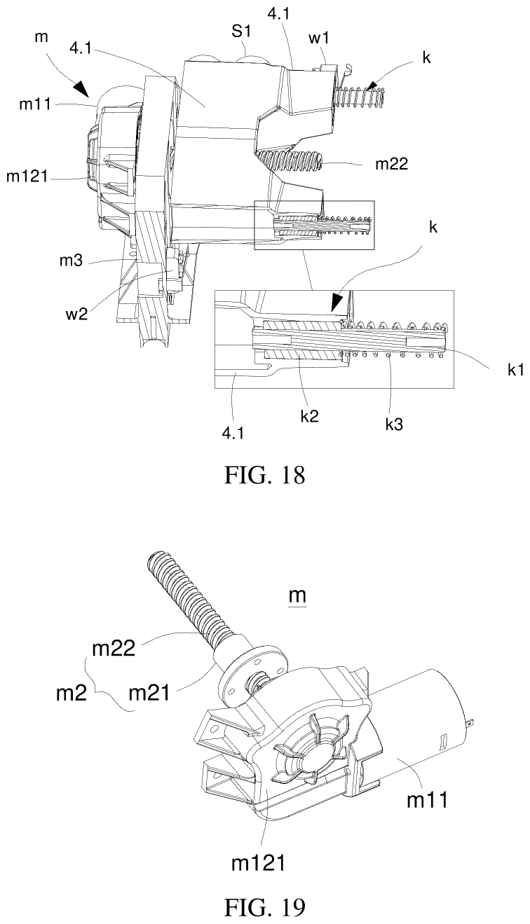

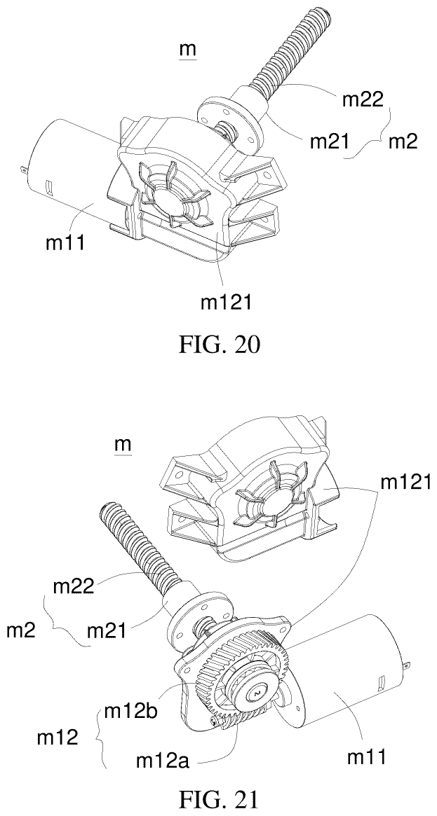

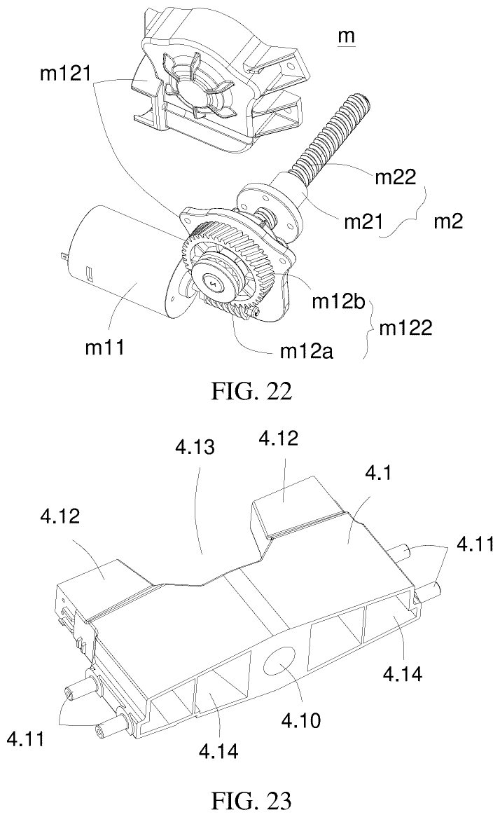

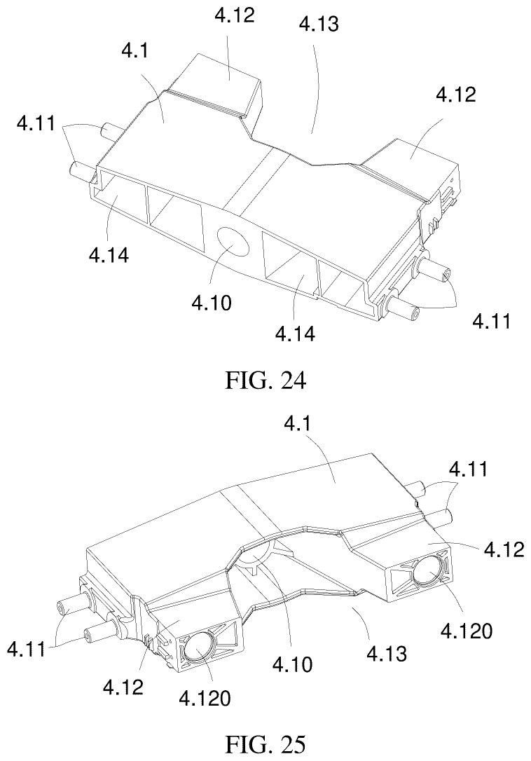

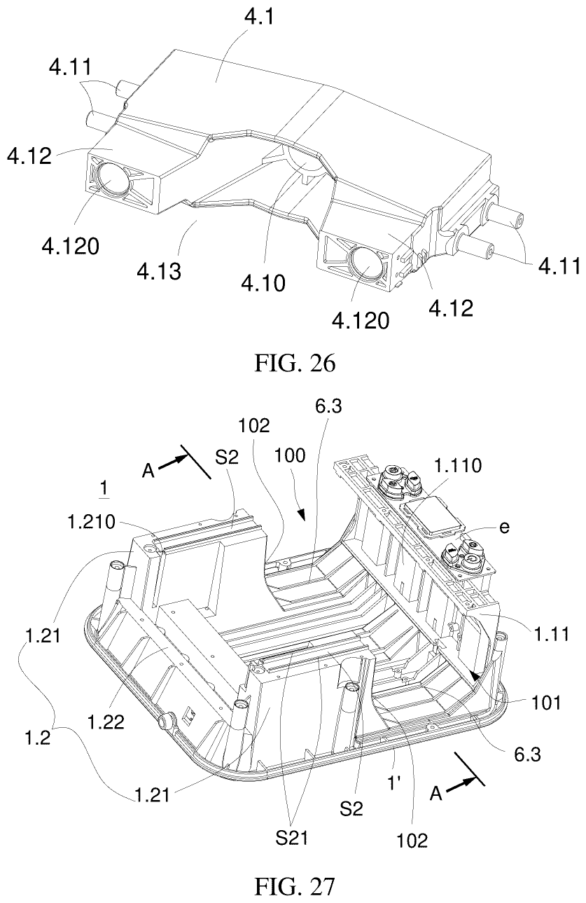

Referring to FIG. 1 to FIG. 26, a mug heat press is provided, which includes a frame 1, a housing 2, a flexible heater 3, a driving device 4, and a guide mechanism 5. The flexible heater 3 has a first port 3.1 and a second port 3.2 arranged horizontally, and a pressing channel 300 having an arc-shaped wall and communicating the first port 3.1 and the second port 3.2. An upper portion the pressing channel 300 has a groove opening 30 defined by a first edge 301 and a second edge of the flexible heater 3. Two ends of the groove opening 30 are respectively in communication with the first port 3.1 and the second port 3.2. An inner diameter of the pressing channel 300 is adjustable via the second edge 302. The driving device 4 includes a transmission member 4.1, elastic coupling members k connecting two sides of the second edge 302 and two sides of the transmission member 4.1, and a driver m configured to drive the transmission member 4.1 to drive the second edge 302 to move relative to the first edge 301.

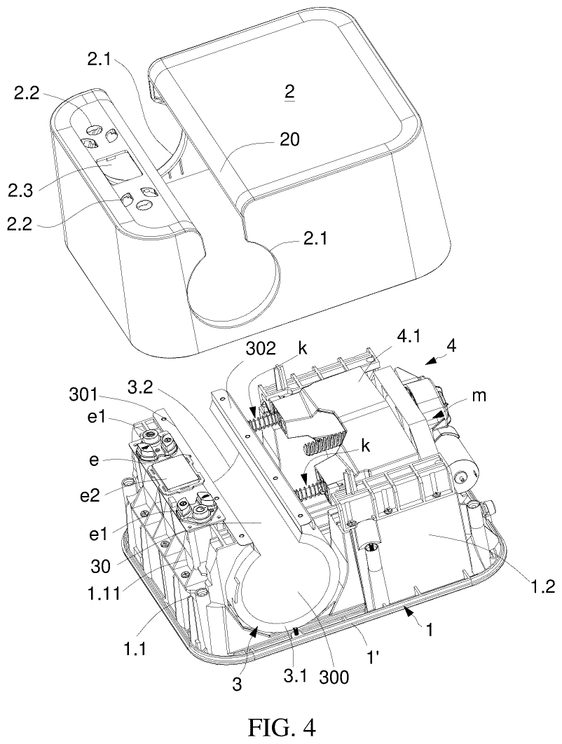

Referring to FIG. 2 and FIG. 4, the housing 2 is arranged surrounding an outer side of the frame 1, i.e., covers a side portion and an upper portion of the frame 1. Two sides of the housing 2 are respectively provided with first openings 2.1 corresponding to the first port 3.1 and the second port 3.2. An upper side of the housing 2 is provided with a second opening 20 corresponding to the groove opening 30. The housing 2 is provided with a control area corresponding to a control circuit board e (i.e., control board). Referring to FIG. 1 to FIG. 3 and FIG. 16, in an embodiment, the control circuit board e includes function buttons e1 and a display module e2 (or a display element). The function buttons e1 include but are not limited to a power switch element, a selector switch element, a temperature adjustment element, a time adjustment element, and the like. The control area on the housing 2 is provided with a function button area 2.2 corresponding to the function buttons e1 and a display area 2.3 corresponding to the display module e2.

Because the pressing channel 300 has openings at both ends, a user can conveniently move an object leftward or rightward to adjust the position of thermal-transfer printing. Automated control is adopted to realize automated pressing, making the operation simple. The elastic coupling members k can ensure a uniform pressure during thermal-transfer printing, thereby improving the effect of thermal-transfer printing.

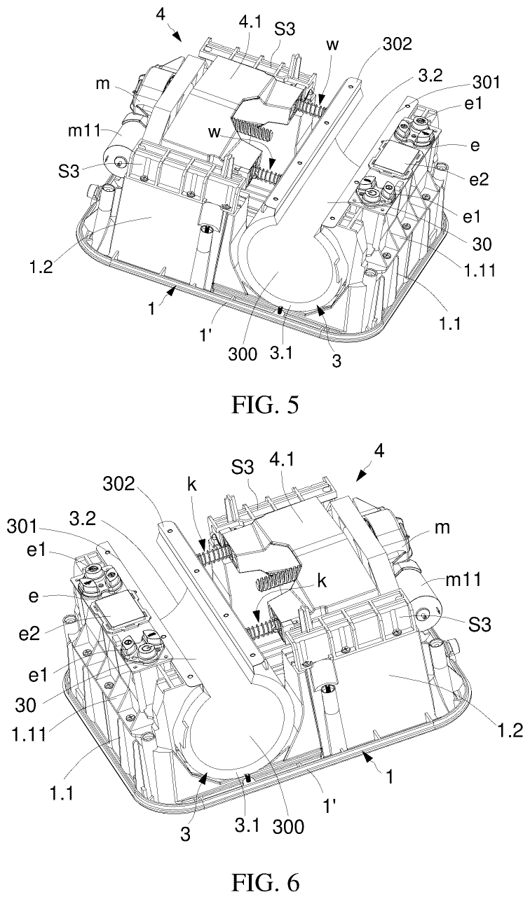

Referring to FIG. 5 to FIG. 10 and FIG. 27, the frame 1 includes a frame bottom wall 1′, and a first mounting part 1.1 and a second mounting part 1.2 formed on the frame bottom wall 1′, a heater mounting chamber 100 with an upper opening is provided between the first mounting part 1.1 and the second mounting part 1.2, the first edge 301 of the flexible heater 3 is mounted on the first mounting part 1.1, the driving device 4 is mounted on the second mounting part 1.2, and the two sides of the transmission member 4.1 are respectively fitted to the second mounting part 1.2 through the guide mechanism 5. Such a configuration optimizes the mounting structure and makes the product structure compact.

Referring to FIG. 15 to FIG. 22, the driver m includes a driving mechanism m1 and a screw nut pair m2, the screw nut pair m2 includes a screw nut m21 and a screw rod m22, the screw nut m21 is connected to the transmission member 4.1, and an output end of the driving mechanism m1 is drive-connected to the screw rod m22.

In the embodiment shown in FIG. 15 to FIG. 22, the driving mechanism m1 includes a motor m11 and a speed variator m12, the motor m11 is drive-connected to an input end of the speed variator m12, and an output end of the speed variator m12 is drive-connected to the screw rod m22.

For example, the speed variator m12 includes a box m121 and a speed change mechanism m122, the motor m11 is horizontally connected to a side portion of the box m121 along an axial direction of the flexible heater 3 and is drive-connected to an input end of the speed change mechanism m122, and an output end of the speed change mechanism m122 is drive-connected to the screw rod m22. The above scheme provides a linear driving force and a well-controlled pressing force and has a compact structure which makes the product small.

In an embodiment, as shown in FIG. 15 to FIG. 22, the speed change mechanism m122 includes a worm m12a and a large gear m12b, a speed reduction is realized by the worm m12a and the large gear m12b, an output shaft of the motor m11 is fixedly connected to the worm m12a, and an end of the screw rod m22 is fixedly connected to the large gear m12b. Because the motor m11 is horizontally connected to the side portion of the box m121 along the axial direction of the flexible heater 3 and is drive-connected to the input end of the speed change mechanism m122, and the length of the flexible heater 3 is greater than that of the motor m11, the product has a compact structure with a smaller height.

In some other embodiments, the driving mechanism m1 may be directly driven by a driver such as a stepping motor or a servomotor.

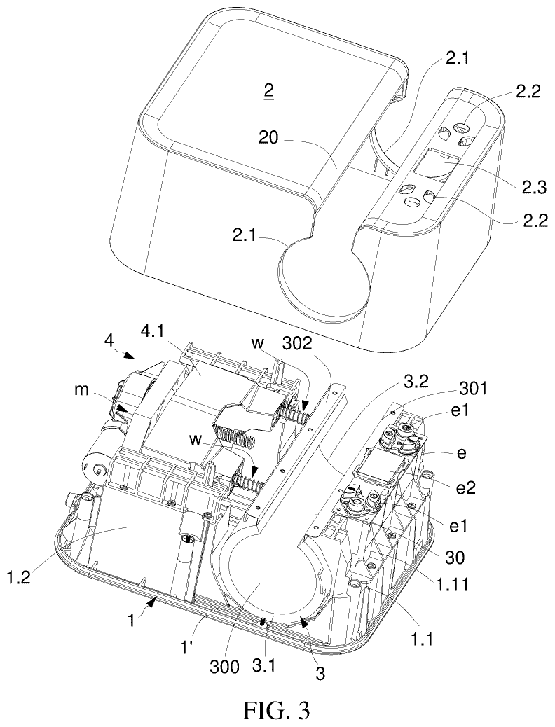

Referring to FIG. 3 to FIG. 10, the second mounting part 1.2 includes two supporting bases 1.21 arranged opposite to each other and perpendicular to an axis of the heater mounting chamber 100, and a driver connection portion 1.22 arranged on rear sides of the two supporting bases 1.21, the transmission member 4.1 is movably mounted on upper sides of the two supporting bases 1.21, and the driver m is mounted on the driver connection portion 1.22. Such a configuration enables the frame 1 to have a high structural strength, further optimizes the mounting structure, and makes the product structure more compact.

Referring to FIG. 3 to FIG. 26, in an embodiment, the two sides of the transmission member 4.1 are respectively fitted to the two supporting bases 1.21 through the guide mechanism 5, and the driver m is mounted on the driver connection portion 1.22.

Referring to FIG. 3 to FIG. 26, in an embodiment, the guide mechanism 5 includes two or more guide wheels S1 arranged at intervals and mounted on the transmission member, and guide grooves S2 respectively provided on upper sides of the two supporting bases. Such a configuration provides more stable guidance.

An upper side of the guide wheel S1 may be positioned by a guide cover S3. The guide cover S3 is mounted on an upper side of the corresponding supporting base 1.21 and covers the upper side of the guide wheel S1. The guide cover S3 is mounted on the upper side of the corresponding supporting base 1.21 by a screw or other commonly used connection methods, such as snap-fit.

Referring to FIG. 3 to FIG. 26, in an embodiment of the mug heat press, the two sides of the transmission member 4.1 are respectively fitted to the second mounting part 1.2 through a guide mechanism 5 (i.e., a torque bias guide mechanism), and the guide mechanism 5 is configured to guide and adjust a movement of the transmission member 4.1. The guide mechanism 5 includes guide wheels S1 mounted on the two sides of the transmission member 4.1, and guide grooves S2 provided on the second mounting part 1.2 and respectively fitted to the guide wheels S1, and a width of the guide groove S2 is configured in a way such that an adjustment clearance exists between the guide groove S2 and the corresponding guide wheel S1. The above scheme achieves a simple and reliable structure and provides a good bias guide effect. When an uneven force is applied to the two sides of the flexible heater 3 due to the influence of, for example, different diameters and shapes of different parts of an object to be printed, the guide mechanism 5 effects an adjustment via the adjustment clearances between the guide wheels S1 and the guide grooves S2, so that the flexible heater 3 and the object to be printed are maintained in press fit. In addition, due to the action of the elastic coupling members k, when an uneven force is applied to the two sides of the flexible heater 3 due to the influence of, for example, different diameters and shapes of different parts of an object to be printed, it can be ensured that a bias adjustment can be effected when the forces received by the two sides of the heat-pressing flexible heater 3 are not balanced.

The guide grooves S2 are respectively provided on upper surfaces of the two supporting bases 1.21, and two or more guide wheels S1 are arranged on each of the two sides of the transmission member 4.1, making the guidance more stable and achieving a better bias adjustment effect. An upper side of the guide wheel S1 may be positioned by a guide cover S3. The guide cover S3 is mounted on an upper side of the corresponding supporting base 1.21 and covers the upper side of the guide wheel S1.

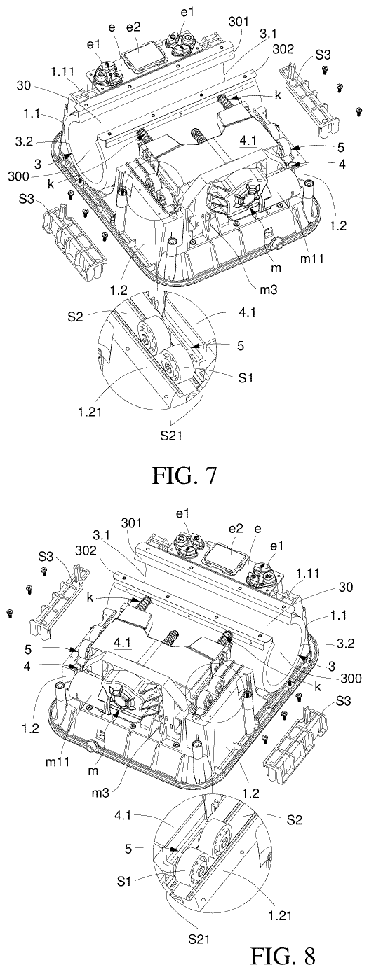

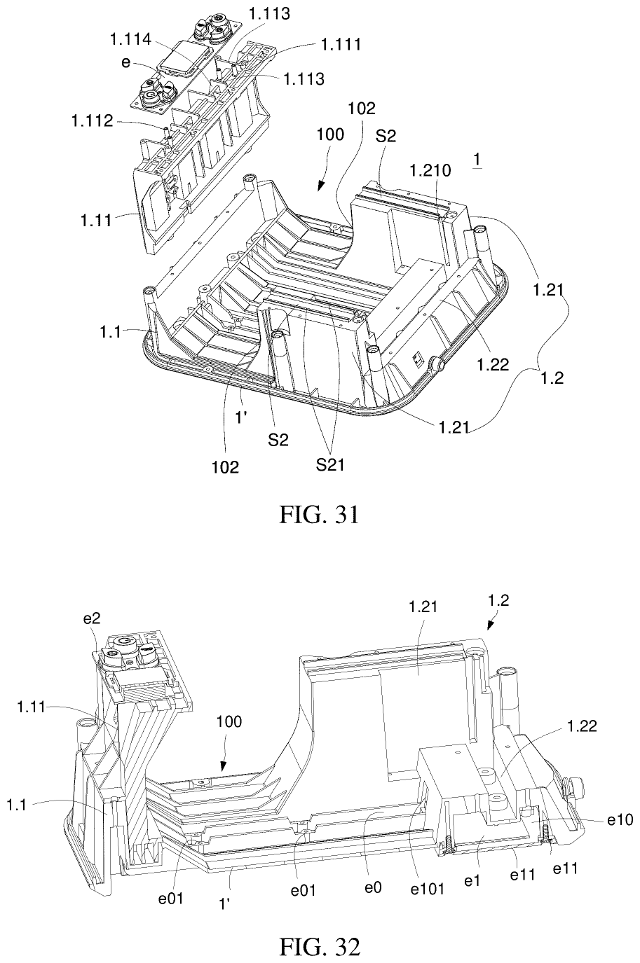

Referring to FIG. 7 to FIG. 10 and FIG. 27 to FIG. 31, the guide groove S2 is defined by two protruding edges S21 injection molded in parallel on the upper surface of the corresponding supporting base 1.21, and a distance between the two protruding edges S21 is designed to be greater than the width of the guide wheel S1, and may be set to, for example, 1 mm to 4 mm, or other values according to actual requirements. The guide grooves S2 may also be fabricated by other existing technical means, such as metal processing.

As for the position of the guide wheels S1 relative to the transmission member 4.1 in the present disclosure, the guide wheels S1 may be mounted on two outer sides of the transmission member 4.1, as in the scheme shown in FIG. 6 to FIG. 7. In some other embodiments, the guide wheels S1 may be arranged below the two sides of the transmission member 4.1 or on a lower side of the transmission member 4.1. To ensure the stability of guidance, two or more sets of guide wheels S1 are required for the transmission member 4.1.

In this embodiment, the arrangement of the guide mechanism 5 (i.e., the torque bias guide mechanism) and the elastic coupling members k can ensure that a bias adjustment is effected via the adjustment clearances when an uneven force is applied to the two sides of the heat-pressing flexible heater 3, to prevent the guide wheels S1 from being stuck in the guide grooves S2 to affect the pressing force, and ensure the conformity between the pressed object and a transfer material and the uniformity of the pressing force. The mug heat press can automatically implement thermal-transfer printing of one object and simultaneous thermal-transfer printing of two objects, and is suitable for thermal-transfer printing of an object with a curved outer diameter without being affected by the placement position of the object, thereby achieving good applicability. For other features, schemes of other embodiments of the present disclosure or a combination thereof may be adopted.

Referring to FIG. 3 to FIG. 18, in an embodiment of the present disclosure, each of the elastic coupling members k includes a guide column k1 connected to the second edge 302, a guide sleeve k2 slidably engaged with the guide column k1 and connected to the transmission member 4.1, and an elastic member k3 mounted between the guide sleeve k2 and the guide column k1. The above scheme provides an elastic resetting effect and a guiding effect, enabling the transmission member 4.1 to move smoothly and achieving a good elastic adjustment effect. The guide column k1 may be connected to the second edge 302 by a fastener such as a screw, welding (where the second edge 302 is provided with a metal connection portion), or other conventionally known connection methods.

Referring to FIG. 13 to FIG. 18 and FIG. 23 to FIG. 26, in an embodiment of the present disclosure, the transmission member 4.1 is injection molded, and includes transmission bases 4.12 arranged at intervals on a side thereof adjacent to the flexible heater 3. Each of the transmission bases 4.12 is provided with a guide sleeve mounting hole 4.120 for mounting the corresponding guide sleeve k2. Each of the guide sleeves k2 is fixedly mounted in the corresponding guide sleeve mounting hole 4.120. An avoidance area 4.13 is formed between the two transmission bases 4.12. A nut mounting hole 4.10 for mounting the screw nut m21 is provided at a center of the transmission base 4.12. The nut m21 is fixedly mounted in the nut mounting hole 4.10. The screw rod m22 is located in the avoidance area 4.13. The two sides of the transmission member 4.1 are injection molded with shaft projections 4.11 for mounting the guide wheels S1.

To increase the structural strength of the transmission member 4.1, a plurality of avoidance cavities 4.14 are provided inside the transmission member 4.1. The arrangement of the avoidance cavities 4.14 can also reduce material consumption and reduce the costs.

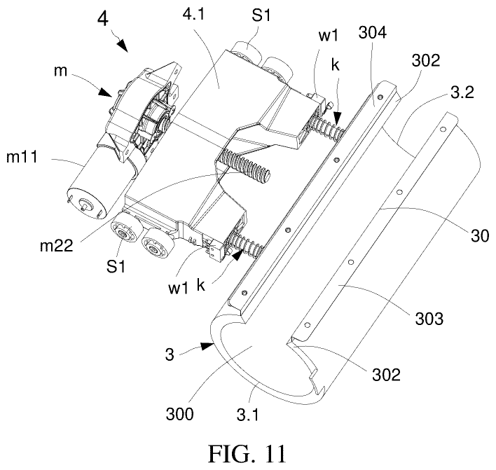

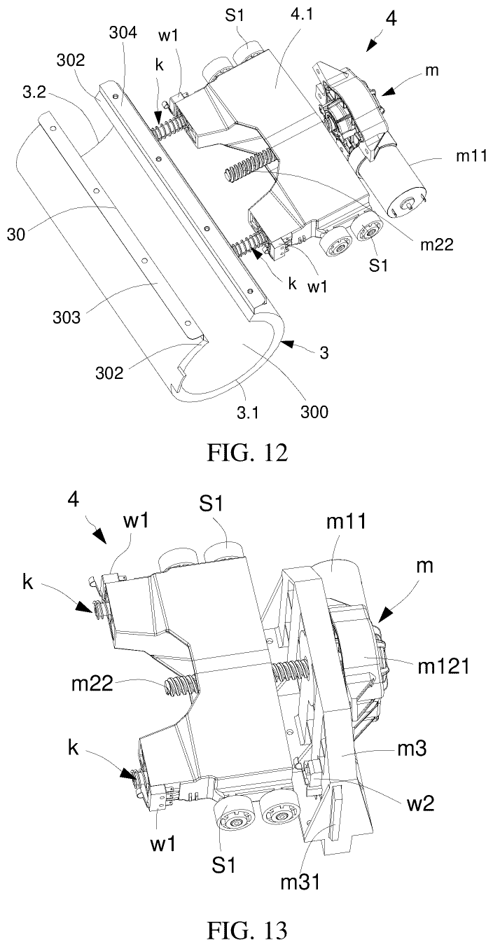

Referring to FIG. 11 and FIG. 12, the flexible heater 3 may adopt a scheme commonly used in the art. To facilitate connection, a first metal connection member 303 is mounted to the first edge 301 of the flexible heater 3, and a second metal connection member 304 is mounted to the second edge 302. The connection between the first edge 301 and the first metal connection member 303 and between the second edge 302 and the second metal connection member 304 is well known in the art. The guide columns k1 are connected to the second metal connection member 304 by screws, rivets, or other fasteners.

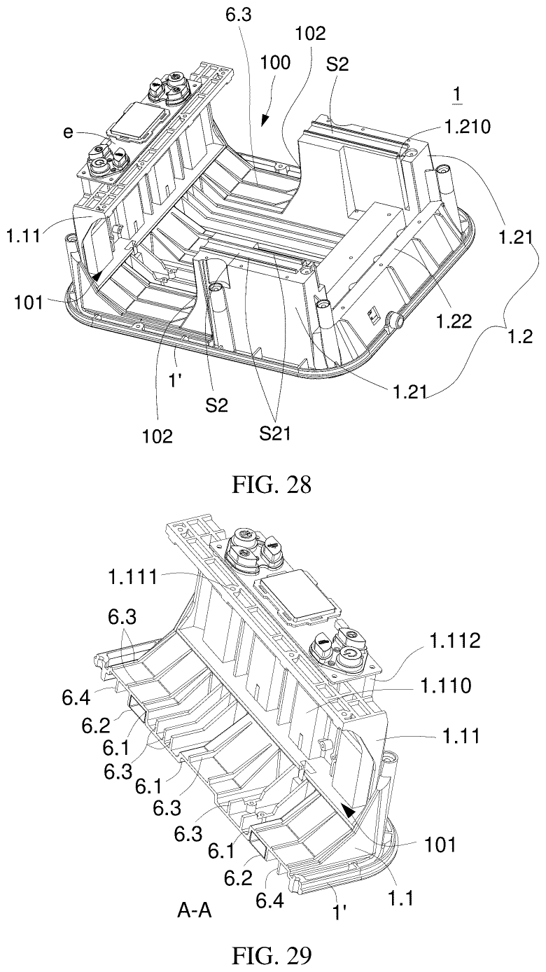

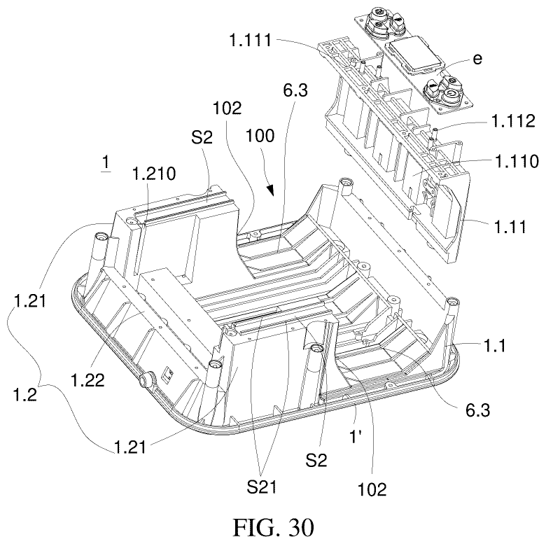

Referring to FIG. 27, FIG. 28, and FIG. 30 to FIG. 33, in an embodiment, a lower portion of the first side wall 101 of the heater mounting chamber 100 is arranged on a side of the first mounting part 1.1 adjacent to the heater mounting chamber 100, and a second side wall 102 of the heater mounting chamber 100 is arranged on a side of the second mounting part 1.2 adjacent to the heater mounting chamber 100. A first connection base 1.11 is mounted on the first mounting part 1.1. An upper portion of the first side wall 101 of the heater mounting chamber 100 is arranged on a side of the first connection base 1.11 adjacent to the heater mounting chamber 100. An upper portion of the first connection base 1.11 is provided with a first connection portion 1.111 and a second connection portion 1.112. The first edge 301 of the flexible heater 3 is fixed to the first connection portion 1.111 through the first metal connection member 303. The control circuit board e is mounted on the second connection portion 1.112. Such a configuration enables the side wall of the heater mounting chamber 100 to have a high strength, thereby achieving high stability and facilitating the production.

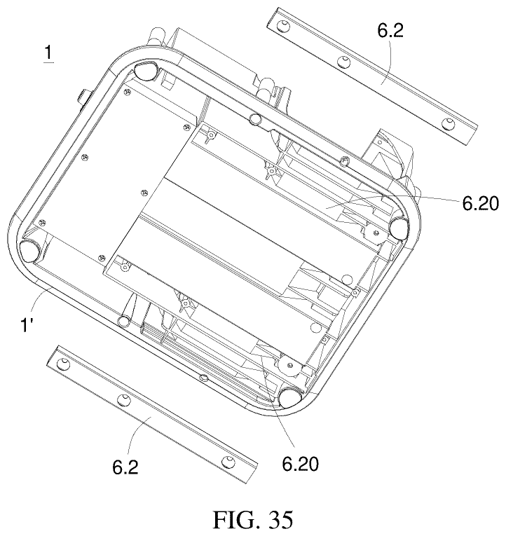

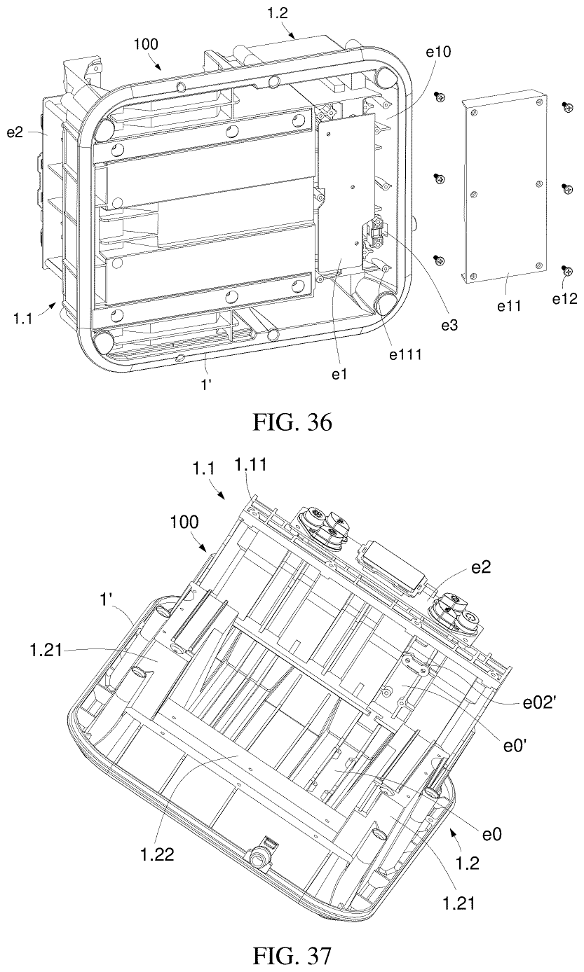

Referring to FIG. 27 to FIG. 37, the frame 1 is injection molded, i.e., the bottom wall 1′, the first mounting part 1.1, and the second mounting part 1.2 are integrally injection molded, and the bottom wall 1′of the frame 1 is formed with a reinforcing rib structure (6.3, 6.4) perpendicular to the axis of the heater mounting chamber 100, and/or a reinforcing member 6.2 mounted at a bottom of the bottom wall 1′ across the heater mounting chamber 100. The reinforcing member 6.2 and the reinforcing rib structure will be described in detail later.

Referring to FIG. 3 to FIG. 18, in an embodiment, a first switch device w1 is mounted on each of side portions of a front side of the transmission member 4.1 that are respectively connected to the elastic coupling members k, the first switch device w1 is electrically connected to the control circuit board e, a second switch device w2 is arranged on a rear side of the transmission member 4.1, and the first switch devices w1 and the second switch device w2 are triggered to cause the driving device 4 to stop operation when the transmission member 4.1 moves to a first pressing position and a second reset position. In an embodiment, the second switch device w2 is mounted on a driving mounting wall m3, the first switch device w1 comes into contact with the second edge 302 and is thus triggered when the transmission member 4.1 moves to the first pressing position, and when the transmission member 4.1 moves to the second reset position, the transmission member 4.1 comes into contact with and thus triggers the second switch device w2.

Referring to FIG. 4 to FIG. 18, in an embodiment, the driver m further includes a driving mounting wall m3, rear sides of the two supporting bases 1.21 are provided with vertical positioning grooves 1.210 facing each other, protruding blocks m31 on two sides of the driving mounting wall m3 are respectively inserted into the positioning grooves 1.210 and fixedly connected to the driver connection portion 1.22 by, for example, screws. The fitting of the positioning grooves 1.210 and the driving mounting wall m3 can restrict the position of the driver m to make the connection between the driver m and the frame 1 more stable, thereby improving the stability of the driver m during operation.

Referring to FIG. 1 to FIG. 18, in an embodiment of the mug heat press, no elastic coupling member k is provided, the front side of the transmission member 4.1 is connected to the second edge 302 of the flexible heater 3 by, for example, a screw, welding, etc. Different from the scheme using the elastic coupling members k, this scheme is suitable for thermal-transfer printing of objects with a uniform diameter, and is also suitable for thermal-transfer printing of objects with a small diameter variation by the deformation of the flexible heater 3. For other features, schemes of other embodiments of the present disclosure or a combination thereof may be adopted.

Referring to FIG. 27 to FIG. 37, in an embodiment of the mug heat press, the frame 1 is injection molded, i.e., the bottom wall 1′, the first mounting part 1.1, and the second mounting part 1.2 are integrally injection molded, the frame 1 is provided with a reinforcing structure 6, and the reinforcing structure 6 includes a stepped structure 6.1 formed on the bottom wall 1′ and extending across the heater mounting chamber 100, and a reinforcing member 6.2 mounted at a bottom of the bottom wall 1′ across the heater mounting chamber 100. For other features, schemes of other embodiments of the present disclosure or a combination thereof may be adopted.

The arrangement of the reinforcing structure 6 on the bottom wall 1′ of the frame 1 can ensure the structural strength of the bottom wall 1′ at the heater mounting chamber 100, so that during thermal-transfer printing, the bottom wall 1′ does not deform to affect the thermal-transfer printing effect. The stepped structure 6.1 and the reinforcing member 6.2 can effectively improve the structural strength of the bottom wall 1′ at the heater mounting chamber 100. The reinforcing structure of the above scheme is cost-effective and lightweight.

In some other embodiments, the reinforcing structure 6 may be one of the stepped structure 6.1 or the reinforcing member 6.2. Alternatively, the stepped structure 6.1 and the reinforcing member 6.2 may also be used in combination, achieving a higher structural strength of the frame 1.

The reinforcing structure 6 further includes a plurality of reinforcing rib structures (6.3, 6.4) formed at intervals on an upper surface and a lower surface of the bottom wall 1′ and perpendicular to an axial direction of the heater mounting chamber 100. Such a configuration can further improve the structural strength of the bottom wall 1′ of the frame 1. In some other embodiments, only reinforcing rib structures 6.3 are arranged on the upper surface of the bottom wall 1′, or only reinforcing rib structures 6.4 are arranged on the lower surface of the bottom wall 1′, as desired.

To further increase the structural strength of the bottom wall 1′ of the frame 1, the reinforcing member 6.2 is preferably a metal reinforcing member 6.2.

Referring to FIG. 28 and FIG. 37, in an embodiment, two or more reinforcing members 6.2 in the form of square profiles are arranged at intervals, and the reinforcing members 6.2 are mounted on the bottom wall 1′ of the frame 1 perpendicularly to the axis of the heater mounting chamber 100. The square profiles have a high structural strength which can significantly improve the structural strength of the bottom wall 1′of the frame 1, and are cost-effective. Accommodating grooves 6.20 perpendicular to the axis of the heater mounting chamber 100 are provided on a lower side of the bottom wall 1′, and the reinforcing members 6.2 are mounted in the accommodating grooves 6.20 by, for example, screws.

In addition, because the two supporting bases 1.21 are arranged spaced apart, this configuration can also improve the structural strength of the frame 1.

Referring to FIG. 27 to FIG. 33, in an embodiment, the reinforcing rib structures 6.3 on the upper surface of the bottom wall 1′ that are between the two supporting bases 1.21 extend to an end of a space between the two supporting bases 1.21, or the reinforcing rib structures 6.3 on the upper surface of the bottom wall 1′ extend to a wall of the heater mounting chamber 100. As such, the structural strength of the wall of the heater mounting chamber 100 and the bottom wall 1′ of the frame 1 can be further improved, and the deformation of the frame 1 during thermal-transfer printing can be further reduced.

Referring to FIG. 27 to FIG. 33, in an embodiment, a lower portion of the first side wall 101 of the heater mounting chamber 100 is arranged on a side of the first mounting part 1.1 adjacent to the heater mounting chamber 100, and a second side wall 102 of the heater mounting chamber 100 is arranged on a side of the second mounting part 1.2 adjacent to the heater mounting chamber 100. A first connection base 1.11 is mounted on the first mounting part 1.1. A vertical wall 1.110 of the first connection base 1.11 is configured as a stepped structure. An upper portion of the first side wall 101 of the heater mounting chamber 100 is arranged on a side of the first connection base 1.11 adjacent to the heater mounting chamber 100. An upper portion of the first connection base 1.11 is provided with a first connection portion 1.111 and a second connection portion 1.112. The first edge 301 of the flexible heater 3 is fixed to the first connection portion 1.111. The control circuit board e is mounted on the second connection portion 1.112. The configuration of the vertical wall of the first connection base 1.11 as a stepped structure can improve the structural strength of the first connection base 1.11, thereby improving the structural strength of the wall of the heater mounting chamber 100.

Referring to FIG. 1 to FIG. 37, in another embodiment of the present disclosure, a heat press is provided, which includes a mug heat press. A control circuit of the heat press includes a main control board el and a control board e2. The second mounting part 1.2 on the bottom wall 1′of the frame 1 is provided with a main control chamber e10 with a lower opening, and a main control chamber cover e11 configured to open and close the main control chamber e10. The main control board e1 is mounted in the main control chamber e10. The control board e2 is mounted on the first mounting part 1.1 of the frame 1. For example, a top of the main control chamber e10 is provided with a connection portion, which may be a connection column, the main control board e1 is fixed to the connection portion by a screw, and the main control chamber cover e11 is fixed to cover connection portions e111 of the main control chamber e10 by screws e12. The main control board e1 is a power board for regulating a power supply. The regulation includes but is limited to voltage transformation, rectification, power output regulation, etc. The implementation principle of the main control board el belongs to the prior art. For other features, schemes of other embodiments of the present disclosure or a combination thereof may be adopted.

The main control board el and the control board e2 are respectively arranged at two ends of the frame 1, to facilitate the mounting and maintenance of the main control board e1 and prevent a heat source, i.e., heat generated by the flexible heater, from affecting the control board e2 and the main control board e1. In addition, the main control board e1 is mounted in the main control chamber e10 which is separated from the driving device m, to prevent a lubricating medium of the driving device m from affecting the main control board e1, so there is no need to provide a protective structure for the main control board e1.

A wiring channel e0 communicating the first mounting part 1.1 of the frame and the main control chamber e10 is provided on an upper side of the bottom wall 1′ of the frame 1. Such a configuration facilitates wiring. For example, the wiring channel e0 is in communication with a communication hole e101 on a side portion of the main control chamber e10, a plurality of wire pressing portions e01 are arranged at intervals in the wiring channel e0, and a wire pressing block (not shown) is arranged on each of the wire pressing portions e01 to fix a position of a wire. A side portion of the main control chamber e10 is further provided with a power cord hole e3 for a power cord to pass through.

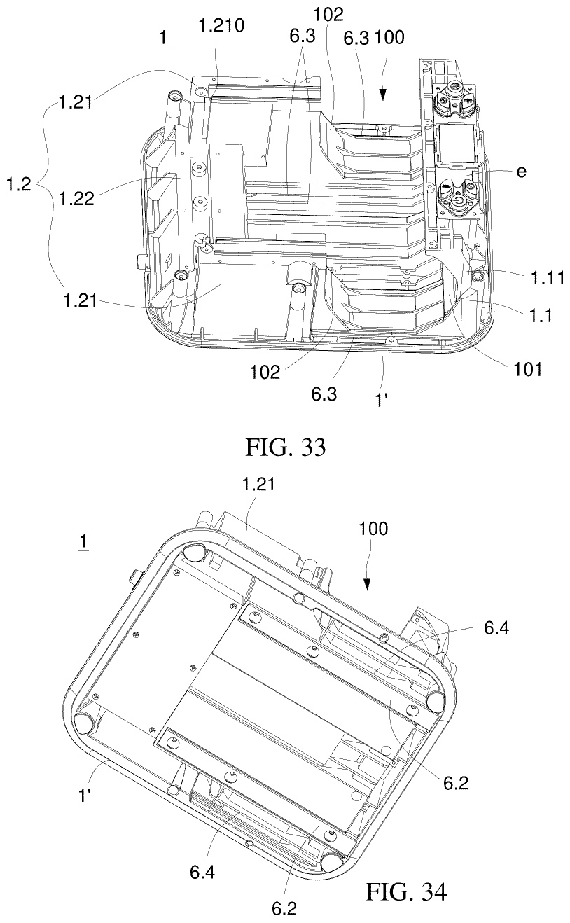

Referring to FIG. 27 and FIG. 33, in an embodiment, a lower portion of the first side wall 101 of the heater mounting area 100 (i.e., heater mounting chamber) is arranged on a side of the first mounting part 1.1 adjacent to the heater mounting area 100, and a second side wall 102 of the heater mounting area 100 is arranged on a side of the second mounting part 1.2 adjacent to the heater mounting area 100. A first connection base 1.11 is mounted on an upper side of the first mounting part 1.1 along a length direction of the heater mounting area 100. An upper portion of the first side wall 101 of the heater mounting area 100 is arranged on a side of the first connection base 1.11 adjacent to the heater mounting area 100. A front side of an upper portion of the first connection base 1.11 is provided with a first connection portion 1.111. The first edge 301 of the flexible heater 3 is fixed to the first connection portion 1.111 through the first metal connection member 303. Such a configuration enables the side wall of the heater mounting area 100 to have a high strength, thereby achieving high stability and facilitating the production.

Referring to FIG. 27 and FIG. 28, the control board e2 is mounted on the upper portion of the first connection base 1.11. The above scheme can improve the heat insulation effect between the control board e2 and the heater mounting chamber 100.

On the upper portion of the first connection base 1.11, a plurality of connection columns 1.112 are arranged, and supporting walls 1.113 are arranged at intervals. An air gap 1.114 is formed between neighboring supporting walls 1.113. The control board e2 is mounted on upper sides of the supporting walls 1.113 and is connected to the connection columns 1.112. The above scheme can further improve the thermal insulation effect by the air gap 1.114.

A wiring channel e0′ is provided on a side of the first connection base 1.11 adjacent to the heater mounting area 100. The wiring channel e0 is in communication with the wiring channel e0′. A wire pressing block e02′ is arranged in the wiring channel e0′.

The embodiments of the present disclosure and the features in the embodiments may be combined with each other and mutually referenced.

According to the disclosure and teaching of the above description, those having ordinary skills in the art can make variations and modifications to the above embodiments. The present disclosure is not limited to the specific embodiments disclosed and described above, and some variations and modifications to the present disclosure shall also fall within the scope of protection of the claims of the present disclosure.

1. A mug heat press, comprising:
a frame;
a flexible heater, having a first port and a second port arranged horizontally, and a pressing channel having an arc-shaped wall and communicating the first port and the second port, wherein an upper portion of the pressing channel has a groove opening defined by a first edge and a second edge of the flexible heater, two ends of the groove opening are respectively in communication with the first port and the second port, and an inner diameter of the pressing channel is adjustable via the second edge; and
a driving device, comprising a transmission member connected to the second edge of the flexible heater, and a driver configured to drive the transmission member to drive the second edge to move relative to the first edge.

2. (canceled)

3. The mug heat press of claim 50, wherein each of the elastic coupling members comprises a guide column connected to the first edge, a guide sleeve slidably engaged with the guide column and connected to the transmission member, and an elastic member mounted between the guide sleeve and the guide column.

4. The mug heat press of claim 1, wherein the driver comprises a driving mechanism and a screw nut pair, the screw nut pair comprises a screw nut and a screw rod, thea screw nut is connected to the transmission member, and an output end of the driving mechanism is drive-connected to the screw rod;
wherein the driving mechanism comprises a motor and a speed variator, the motor is drive-connected to an input end of the speed variator, and an output end of the speed variator is drive-connected to the screw rod.

5. (canceled)

6. The mug heat press of claim 1, wherein the frame comprises a frame bottom wall, and a first mounting part and a second mounting part formed on the frame bottom wall, a heater mounting chamber with an upper opening is provided between the first mounting part and the second mounting part, the first edge of the flexible heater is mounted on the first mounting part, and the driver is mounted on the second mounting part.

7. The mug heat press of claim 6, wherein the second mounting part comprises two supporting bases arranged opposite to each other and perpendicular to an axis of the heater mounting chamber, two sides of the transmission member are respectively fitted to the two supporting bases through a guide mechanism, and the driver is mounted on rear sides of the two supporting bases.

8. The mug heat press of claim 7, wherein a driver connection portion is arranged on the rear sides of the two supporting bases, the driver is mounted on the driver connection portion, the driver comprises a driving mechanism and a screw nut pair, the screw nut pair comprises a screw nut and a screw rod, the screw nut is connected to the transmission member, the driving mechanism comprises a motor and a speed variator, the motor is drive-connected to an input end of the speed variator, and an output end of the speed variator is drive-connected to the screw rod.

9. The mug heat press of claim 6, wherein the frame is injection molded, and the frame bottom wall is formed with a plurality of reinforcing rib structures perpendicular to an axis of the heater mounting chamber, and/or a reinforcing member extending across the heater mounting chamber is mounted on the frame bottom wall.

10. The mug heat press of claim 50, wherein a first switch device is mounted on each of side portions of a front side of the transmission member that are respectively connected to the elastic coupling members, the first switch device is electrically connected to the control circuit board, a second switch device is arranged on a rear side of the transmission member, and the first switch devices and the second switch device are triggered to cause the driving device to stop operation when the transmission member moves to a first pressing position and a second reset position.

11-16. (canceled)

17. The mug heat press of claim 6, wherein a lower portion of a first side wall of the heater mounting chamber is arranged on a side of the first mounting part adjacent to the heater mounting chamber, and a second side wall of the heater mounting chamber is arranged on a side of the second mounting part adjacent to the heater mounting chamber; and a first connection base is mounted on the first mounting part, an upper portion of the first side wall of the heater mounting chamber is arranged on a side of the first connection base adjacent to the heater mounting chamber, an upper portion of the first connection base is provided with a first connection portion and a second connection portion, the first edge of the flexible heater is fixed to the first connection portion, and a control circuit board is mounted on the second connection portion.

18. The mug heat press of claim 17, further comprising a housing, wherein the housing is arranged surrounding an outer side of the frame, two sides of the housing are respectively provided with first openings corresponding to the first port and the second port, an upper side of the housing is provided with a second opening corresponding to the groove opening, and the housing is provided with a control area corresponding to the control circuit board.

19-30. (canceled)

31. A mug heat press, comprising:
a frame, which is injection molded and comprises a bottom wall, and a first mounting part and a second mounting part formed on an upper side of the bottom wall of the frame, wherein a heater mounting chamber with an upper opening is provided between the first mounting part and the second mounting part;
a reinforcing structure, comprising a stepped structure formed on the bottom wall and extending across the heater mounting chamber, and/or a reinforcing member mounted at a bottom of the bottom wall across the heater mounting chamber;
a flexible heater, having a first port and a second port arranged horizontally, and a pressing channel having an arc-shaped wall and extending to the first port and the second port, wherein an upper portion of the pressing channel has a groove opening defined by a first edge and a second edge of the flexible heater, two ends of the groove opening are respectively in communication with the first port and the second port, the first edge of the flexible heater is mounted on the first mounting part, and an inner diameter of the pressing channel is adjustable via the second edge; and
a driving device, mounted on the second mounting part, and comprising a transmission member connected to the second edge of the flexible heater, and a driver configured to drive the transmission member to drive the second edge to move relative to the first edge.

32. The mug heat press of claim 31, wherein the reinforcing structure further comprises a plurality of reinforcing rib structures formed at intervals on an upper surface and/or a lower surface of the bottom wall and perpendicular to an axial direction of the heater mounting chamber.

33. The mug heat press of claim 31, wherein the reinforcing member is a metal reinforcing member.

34. The mug heat press of claim 31, wherein two or more reinforcing members in the form of square profiles are arranged at intervals, and the two or more reinforcing members are mounted on the bottom wall of the frame perpendicularly to an axis of the heater mounting chamber.

35-36. (canceled)

37. The mug heat press of claim 32, wherein the reinforcing rib structures on an upper surface of the bottom wall extend to a wall of the heater mounting chamber.

38-39. (canceled)

40. The mug heat press of claim 31, wherein the second mounting part comprises two supporting bases arranged opposite to each other and perpendicular to an axis of the heater mounting chamber, the driver comprises a driving mounting wall, rear sides of the two supporting bases are provided with vertical positioning grooves facing each other, the driving mounting wall is inserted into the positioning grooves and fixedly connected to the driver connection portion.

41-49. (canceled)

50. The mug heat press of claim 1, further comprising elastic coupling members connecting two sides of the second edge and two sides of the transmission member.

51. The mug heat press of claim 8, wherein the driver comprises a driving mounting wall, the rear sides of the two supporting bases are provided with vertical positioning grooves facing each other, the driving mounting wall is inserted into the positioning grooves and fixedly connected to the driver connection portion.

52. A mug heat press, comprising:
a frame;
a flexible heater, having a first port and a second port arranged horizontally, and a pressing channel having an arc-shaped wall and communicating the first port and the second port, wherein an upper portion of the pressing channel has a groove opening defined by a first edge and a second edge of the flexible heater, two ends of the groove opening are respectively in communication with the first port and the second port, and an inner diameter of the pressing channel is adjustable via the second edge;
a driving device, comprising a transmission member connected to the second edge of the flexible heater, and a driver configured to drive the transmission member to drive the second edge to move relative to the first edge; and
a torque bias guide mechanism, arranged on two sides of the transmission member and configured to guide and adjust a movement of the transmission member.

53. The mug heat press of claim 52, wherein the torque bias guide mechanism comprises a guide wheel mounted on the transmission member and a guide groove configured to be fitted with the guide wheel, and a width of the guide groove is configured in a way such that an adjustment clearance exists between the guide groove and the guide wheel.
